(19) United States
(12) Patent Application Publication
(10) Pub. No.: US 2008/0235875 A1
(43) Pub. Date: Oct. 2, 2008

(54) MATERNITY BED AND PATIENT LYING SURFACE THEREFOR

(75) Inventor: Larry A. Wells, Kalamazoo, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: STRYKER CORPORATION, Kalamazoo, MI (US)

(21) Appl. No.: 12/057,665

(22) Filed: Mar. 28, 2008

Related U.S. Application Data
(60) Provisional application No. 60/920,381, filed on Mar. 28, 2007.

(51) Int. Cl. A61G 7/00

(52) U.S. Cl. 5/602

(57) ABSTRACT

A maternity bed incorporates a patient lying surface with pelvis, lumbar, and upper back regions, and left and right sides. The lying surface has two or more actuatable lifting elements arranged at the lying surface, and may incorporate four or six or more lifting elements. The lifting elements may include a left pelvis lifting element and a right pelvis lifting element at the pelvis region of the lying surface, a left lumbar lifting element and a right lumbar lifting element at the lumbar region of the lying surface, and a left upper back lifting element and a right upper back lifting element at the upper back region of the lying surface. At least one actuator may actuate the lifting elements to raise and lower various regions of a patient, such as to provide a turning function, and may be controlled by a user input device.

### CROSS REFERENCE TO RELATED APPLICATION

The present application claims the benefit of U.S. provisional application Ser. No. 60/920,381, filed Mar. 28, 2007, which is hereby incorporated herein by reference in its entirety.

### FIELD OF THE INVENTION

The present invention relates in general to the field of hospital-type beds. In particular, the invention relates to maternity patient beds.

### SUMMARY OF THE INVENTION

The present invention provides a patient lying surface that is configured to turn a patient to one side, or to raise or lower or twist various portions of the patient's body. The lying surface is operable to raise or lower the patient's left or right side, or to raise or lower a selected portion thereof, such as to adjust comfort or provide therapy to the patient.

According to one form of the present invention, a patient lying surface includes a patient lying surface having a seat or pelvis region, a lumbar region, an upper back region, left and right sides, and two or more lifting elements arranged at the lying surface. The lifting elements include a left pelvis lifting element and a right pelvis lifting element located near the pelvis region of the lying surface.

In one aspect, the patient lying surface further includes a left lumbar lifting element and a right lumbar lifting element located at the lumbar region of the patient lying surface. Additional elements may be provided such as a left upper back lifting element and a right upper back lifting element located at the upper back region of the patient lying surface. According to a further aspect, the left pelvis lifting element, the left lumbar lifting element, and the left upper back lifting element are actuatable and deactuatable, either individually or collectively in a group, relative to the right pelvis lifting element, the right lumbar lifting element, and the right upper back lifting element, for turning a patient.

According to another aspect, a user input device provides at least one of: a left turn assist function, a right turn assist function, upper back functions, lumbar functions, pelvis functions, and combined functions.

In the left turn assist function, at least one of the right pelvis lifting element, the right lumbar lifting element, and the right upper back lifting element are actuated relative to the left pelvis lifting element, the left lumbar lifting element, and the right upper back lifting element.

In the right turn assist function, at least one of the left pelvis lifting element, the left lumbar lifting element, and the left upper back lifting element are actuated relative to the right pelvis lifting element, the right lumbar lifting element, and the right upper back lifting element.

The upper back functions include an upper back raising function in which the upper back lifting elements are actuated. A left upper back raising function actuates the left upper back lifting element. A right upper back raising function actuates the right upper back lifting element. An upper back lowering function deactuates the upper back lifting elements. A left upper back lowering function deactuates the left upper back lifting element. A right upper back lowering function deactuates the right upper back lifting element.

The lumbar functions include a lumbar raising function in which the lumbar lifting elements are actuated. A left lumbar raising function actuates the left lumbar lifting element. A right lumbar raising function actuates the right lumbar lifting element. A lumbar lowering function deactuates the lumbar lifting elements. A left lumbar lowering function deactuates the left lumbar lifting element. A right lumbar lowering function deactuates the right lumbar lifting element.

The pelvis functions include a pelvis raising function in which the pelvis lifting elements are actuated. A left pelvis raising function actuates the left pelvis lifting element. A right pelvis raising function actuates the right pelvis lifting element. A pelvis lowering function deactuates the pelvis lifting element. A left pelvis lowering function deactuates the left pelvis lifting element. A right pelvis lowering function deactuates the right pelvis lifting element.

The combined functions include an all-raising function that simultaneously actuates the upper back lifting elements, the lumbar lifting elements, and the pelvis lifting elements are actuated simultaneously. An all-lowering function simultaneously deactuates the upper back lifting elements, the lumbar lifting elements, and the pelvis lifting elements.

According to another form of the invention, a patient lying surface comprises a patient lying surface having a pelvis region, a lumbar region, an upper back region, and left and right sides. The patient lying surface incorporates at least four actuatable lifting elements, the lifting elements arranged at the patient lying surface. At least two of the lifting elements comprise a left lumbar/upper back/pelvis lifting element and a right lumbar/upper back/pelvis lifting element.

According to one aspect, one of the lifting elements comprises a lumbar lifting element at the lumbar region of the patient lying surface, and another lifting element comprises a pelvis lifting element at the pelvis region of the patient lying surface.

In another aspect, each of the lumbar/upper back/pelvis lifting elements has a wide portion at the upper back region of the patient lying surface and further having a narrow portion at the lumbar and pelvis region of the patient lying surface. For example, the lumbar/upper back/pelvis lifting elements may comprise generally P-shaped lifting elements. In still another aspect, each of the lumbar/upper back/pelvis lifting elements has a substantially constant cross section. For example, the lumbar/upper back/pelvis lifting elements may comprise generally rectangular-shaped lifting elements. Additionally, the left and right lumbar/upper back/pelvis lifting elements have substantially the same shape and may be arranged generally in a mirror image to one another.

In a further aspect, the left lumbar/upper back/pelvis lifting element is independently actuatable and deactuatable relative to the right lumbar/upper back lifting element for turning a patient. Similarly, the lumbar/upper back/pelvis lifting elements and the pelvis lifting elements are independently actuatable and deactuatable relative to the other lifting elements.

In another aspect, the pelvis lifting element, the lumbar lifting element, and the lumbar/upper back/pelvis lifting elements are independently actuatable and deactuatable in response to the user input device to raise and lower the pelvis region, the lumbar region, and the upper back region, respectively, of the patient lying surface.

In still another aspect, the user input device provides at least one of a left turn assist function, a right turn assist function, an upper back raising function, an upper back lowering function, a lumbar raising function, a lumbar lowering function, a pelvis raising function, a pelvis lowering function, and a combined function. The left turn assist function actuates the right lumbar/upper back/pelvis lifting element relative to the left lumbar/upper back/pelvis lifting element. The right turn assist function actuates the left lumbar/upper back/pelvis lifting element relative to the right lumbar/upper back/pelvis lifting element. The upper back raising function actuates the lumbar/upper back/pelvis lifting elements. The upper back lowering function deactuates the lumbar/upper back/pelvis lifting elements. The lumbar raising function actuates the lumbar lifting element. The lumbar lowering function deactuates the lumbar lifting element. The pelvis raising function actuates the pelvis lifting element. The pelvis lowering function deactuates the pelvis lifting element. The all-raising function simultaneously actuates the lumbar/upper back/pelvis lifting elements, the lumbar lifting element, and the pelvis lifting element. The all-lowering function simultaneously deactuates the lumbar/upper back/pelvis lifting elements, the lumbar lifting element, and the pelvis lifting element.

In another aspect, any of the patient lying surfaces may be provided on a maternity bed to thereby provide a maternity patient lying surface. In a further aspect, the lifting elements comprise inflatable bladders, with the patient lying surface further including conduits for directing a pressurized fluid from a pressurized fluid source to each of the bladders, a remotely actuatable valve for selectively controlling the passage of the pressurized fluid through each of the conduits to each of the bladders, and a user input device for remotely actuating each of the remotely actuatable valves. The pressurized fluid may be air, water, or other suitable fluid.

In still other aspects, the lifting elements comprise rigid or semi-rigid actuatable panels, with the patient lying surface further including at least one actuator, such as a pneumatic, electric, or hydraulic actuator. The patient lying surface may further include an actuator operatively associated with each lifting element, and a user input device for actuating and deactuating the actuator.

In yet another aspect, a cushion may be disposed upon any of the patient lying surfaces, the cushion being made of foam or other suitably soft and strong material, and optionally incorporate a gas- or liquid-impermeable cover sheet.

Accordingly, the patient lying surface allows a caregiver or patient to raise, lower, support, and/or turn a patient, or just a portion of a patient, by selectively actuating or deactuating one or more actuatable lifting elements that are incorporated by the patient lying surface.

These and other objects, advantages, purposes, and features of the present invention will become apparent upon review of the following specification in conjunction with the drawings.

### BRIEF DESCRIPTION OF THE DRAWINGS

FIG. 1 is a perspective view of a maternity bed of the present invention;

FIG. 2 is an exploded perspective view of a patient lying surface in accordance with the present invention, wherein the patient lying surface is inverted;

FIG. 3 is a perspective view of the patient lying surface of FIG. 2, wherein the patient lying surface is righted;

FIG. 4A is a perspective view of the patient lying surface of FIG. 2, wherein the pelvis bladders are inflated;

FIG. 4B is a perspective view of the patient lying surface of FIG. 4A, wherein the patient lying surface is righted;

FIG. 5A is a perspective view of the patient lying surface of FIG. 2, wherein the lumbar bladders are inflated;

FIG. 5B is a perspective view of the patient lying surface of FIG. 5A, wherein the patient lying surface is righted;

FIG. 6A is a perspective view of the patient lying surface of FIG. 2, wherein the right pelvis bladder, right lumbar bladder, and right upper back bladder are inflated;

FIG. 6B is a perspective view of the patient lying surface of FIG. 6A, wherein the patient lying surface is righted;

FIG. 7 is an exploded perspective view of another patient lying surface in accordance with the present invention, wherein the patient lying surface is inverted;

FIG. 8 is a perspective view of the patient lying surface of FIG. 7, wherein the pelvis bladder is inflated;

FIG. 9A is a perspective view of the patient lying surface of FIG. 7, wherein the left lumbar/upper back/pelvis bladder is inflated;

FIG. 9B is a perspective view of the patient lying surface of FIG. 9A, wherein the patient lying surface is righted;

FIG. 10 is a perspective view of the patient lying surface of FIG. 7, wherein the lumbar bladder is inflated;

FIG. 11 is an exploded perspective view of another patient lying surface in accordance with the present invention, wherein the patient lying surface is inverted;

FIG. 12 is a perspective view of the patient lying surface of FIG. 11, wherein the pelvis bladder is inflated;

FIG. 13 is a perspective view of the patient lying surface of FIG. 11, wherein the lumbar bladder is inflated;

FIG. 14A is a perspective view of the patient lying surface of FIG. 11, wherein the left main bladder is inflated;

FIG. 14B is a perspective view of the patient lying surface of FIG. 14A, wherein the patient lying surface is righted;

FIG. 15 is a side sectional view of a patient lying surface taken along the section designated XV of FIG. 3;

FIG. 16 is a perspective view of the patient lying surface of FIG. 2 and showing additional features in accordance with the present invention;

FIG. 17 is an exploded perspective view of a control assembly in accordance with the present invention; and

FIG. 18 is a perspective view of another patient lying surface in accordance with the present invention, wherein the patient lying surface is inverted.

### DESCRIPTION OF THE PREFERRED EMBODIMENTS

The present invention is directed to a bed, and more specifically, a maternity bed. The bed incorporates an adjustable patient lying surface that assists medical personnel in the repositioning and turning of patients in their care, and assists a patient in labor by allowing medical personnel to raise and/or turn specific portions of the patient's body, such as to enhance comfort and reduce blood pressure during the delivery process.

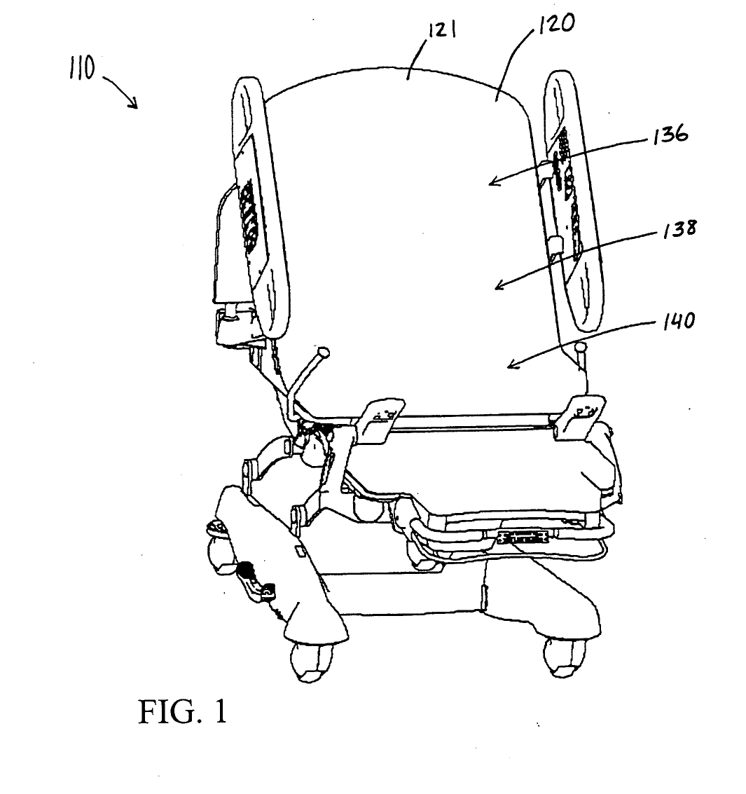

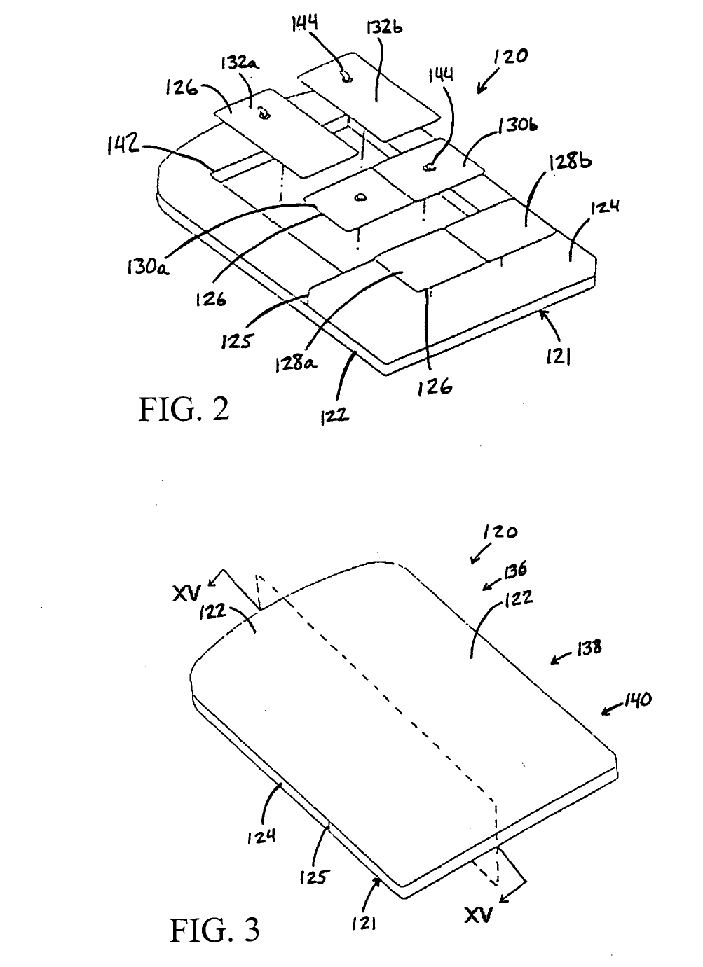

Referring now to FIG. 1, the numeral 110 designates a maternity bed of the present invention. For example, suitable maternity beds are described in commonly assigned U.S. Pat. Nos. 5,926,878; 5,862,549; and 5,774,914, all of which are hereby incorporated herein by reference in their entireties. Bed 110 incorporates a patient lying surface 120 with a cushion 121 that is formed from a top cushion layer 122 and a bottom cushion layer 124, and further incorporates a plurality of actuatable lifting elements, such as inflatable bladders 126, which are provided at cushion 121, as shown in FIG. 2. As will be more fully described below, the lifting elements are incorporated at the cushion 121 to raise and lower regions or portions thereof.

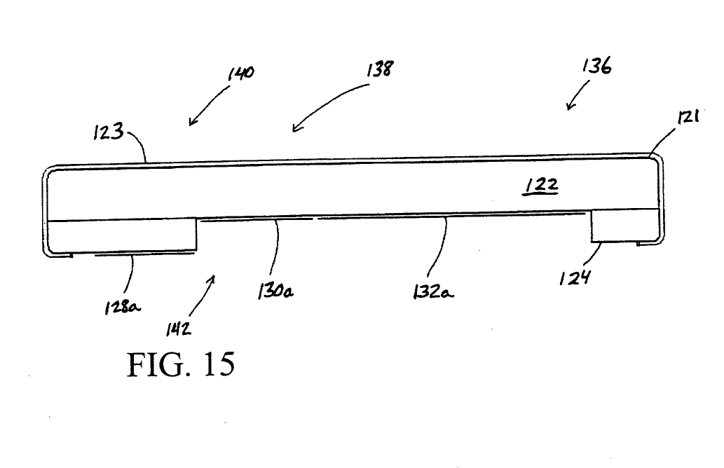

In the illustrated embodiment, top cushion layer 122 comprises the primary cushioning surface on which a patient lies and is generally rectangular in shape. Configured for use with a maternity bed 110, patient lying surface 120, including top cushion layer 122 and bottom cushion layer 124, is shorter in length than a typical hospital or patient bed, and comprises an upper back region 136, a lumbar region 138, and a seat or pelvis region 140 (FIG. 3). Top cushion layer 122 is arranged on top of and may be connected to bottom cushion layer 124, such as with a zipper, hook-and-loop fasteners, adhesive, flexible ties, or the like. Cushion 121 may incorporate an overlay, such as a sheet 123 (FIG. 15), to enhance cushion's 121 utility and reusability.

Top cushion layer 122 incorporates one or more of the following qualities: it may be soft, flexible, stretchable, fire retardant, and easy to clean; it may have antifungal and/or antibacterial properties; and it may be substantially impermeable to gases and liquids, for example. Top cushion layer 122 may be made of foam, for example, and may be made of urethane based materials, such as nylon-based fabric with a polyurethane transfer coating, or vinyl based or vinyl coated materials, or polyvinyl chloride (PVC), or polyolefin laminated or coated fabrics, or other heat sealable covering materials with antibacterial, antifungal, and/or fluid penetration resistant characteristics.

According to the illustrated embodiment, bottom cushion layer 124 has a substantially similar rectangular shape to top cushion layer 122 and incorporates substantially the same material properties to top cushion layer 122, though it should be understood that bottom cushion layer 124 may have a different shape than top cushion layer 122 and, further, may be made from different materials than top cushion layer 122. Although shown as a separate component, bottom cushion layer 124 may be integrated with top cushion layer 122 to form a single monolithic cushion.

In the illustrated embodiments, bottom cushion layer 124 incorporates a lateral slit or gap 125. The lateral slit or gap 125 is located so that patient lying surface 120 may be bent about a lateral axis, such as between lumbar region 138 and pelvis region 140, to achieve a sitting-up position, such as is shown in FIG. 1.

In the illustrated embodiment, the lifting elements comprise inflatable bladders 126. Further, bladders 126 include left and right seat or pelvis bladders 128a, 128b, left and right lumbar bladders 130a, 130b, and left and right upper back bladders 132a, 132b, as shown in FIGS. 2, 4A, 5A, and 6A. Additionally, each bladder 126 is configured to inflate and deflate to thus raise and lower a portion of patient lying surface 120, in response to a user input received from a user input device 134, as will be described in greater detail below. It should be noted that the views of cushion 121 in FIGS. 2, 4A, 5A, 6A, 7, 8, 9A, 10-13, 14A, and 18 are inverted views.

Referring to FIGS. 2, 4A, 5A, and 6A, bottom cushion layer 124 defines an optional cavity 142 that is adapted to receive left and right lumbar bladders 130a, 130b and left and right upper back bladders 132a, 132b. By confining the bladders in a cavity, inflation of the bladders results in that region of the cushion over the inflated bladder being raised or lifted. In addition to allowing a user to raise and lower lumbar region 138 and upper back region 136, cavity 142 facilitates the use of left and right lumbar bladders 130a, 130b and left and right upper back bladders 132a, 132b to adjust the firmness of lumbar region 138 and upper back region 136, respectively. Optionally, cavity 142 may be adapted to receive all the bladders, or any combination of the bladders, or may be compartmentalized with one or more partitions to receive one or more bladders in one or more sub-compartments or sub-cavities (not shown).

It will be appreciated by those skilled in the art that neither top cushion layer 122 nor bottom cushion layer 124 are necessary to practice the invention, and the scope of the invention is not limited to embodiments having a cushion that is separate or distinct from the inflatable bladders or any other type of actuatable lifting elements. Similarly, although depicted in the illustrative embodiments as being disposed beneath at least top cushion layer 122, those skilled in the art will recognize that lifting elements or bladders 126 may be located in or atop top cushion layer 122 or incorporated into bed 110, or generally located anywhere beneath a patient lying on patient lying surface 120, such that lifting elements or bladders 126 lift or support the patient.

Referring to FIG. 2, although inflatable bladders 126 are illustrated as generally rectangular in shape and arranged generally symmetrically along either side of a longitudinal centerline of patient lying surface 120, bladders 126 may have other shapes and may be positioned in different arrangements. For example, bladders 126 may be pillow shape, wedge shape, round, spherical, or multi-chambered, for example, and may incorporate bumps or ridges or the like, without departing from the scope of the invention. Further, bladders 126 may have either substantially constant wall thicknesses or varying wall thicknesses so that when inflated, bladders 126 may have a substantially uniform shape or a non-uniform shape, respectively. Alternately, bladders 126 may be formed from materials having varying elasticity so that when inflated their wall thicknesses vary to thereby vary the shape of the inflated bladder. It will be appreciated that while actuatable lifting elements are generally represented by inflatable bladders 126 in the drawings and the illustrative embodiments primarily described herein, additional embodiments of actuatable lifting elements are envisioned, as will be described in greater detail below.

Inflatable bladders 126 may be connected to a bottom surface of top cushion layer 122 and/or a bottom surface of bottom cushion layer 124, such as with adhesive, hook-and-loop fasteners, straps, ties, or the like, or, alternatively, may be received by separate cavities (not shown) in top cushion layer 122 or bottom cushion layer 124. Bladders 126 are arranged such that pelvis bladders 128a, 128b are generally located at the pelvis region 140 of cushion 121, lumbar bladders 130a, 130b, are generally located at the lumbar region 138 of cushion 121, and upper back bladders 132a, 132b are generally located at the upper back region 136 of cushion 121.

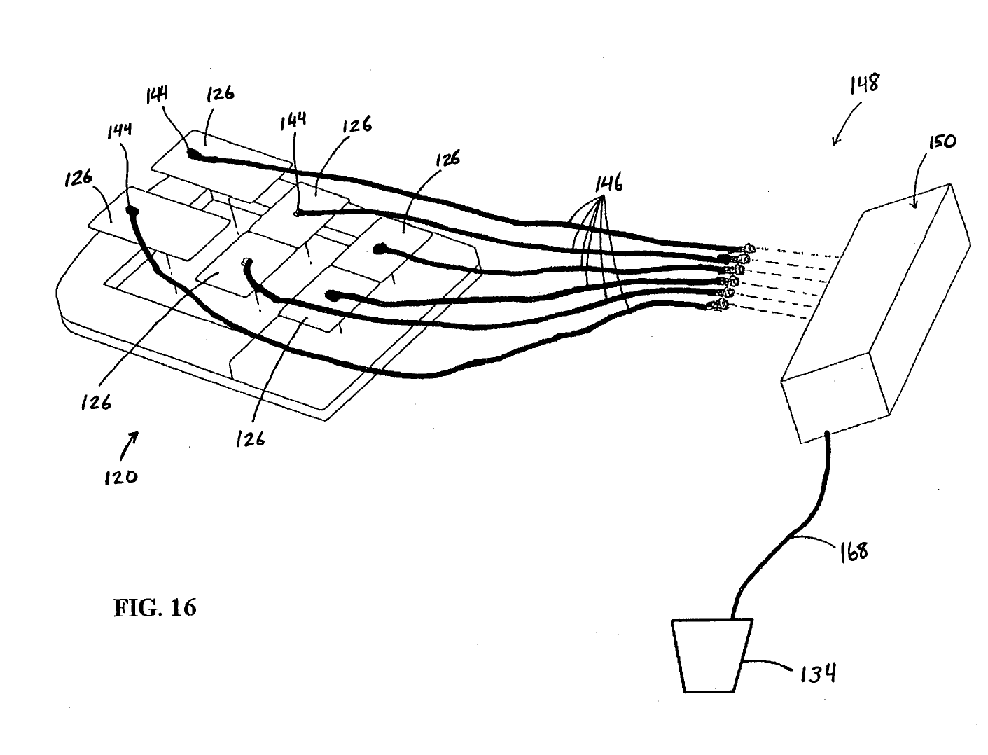

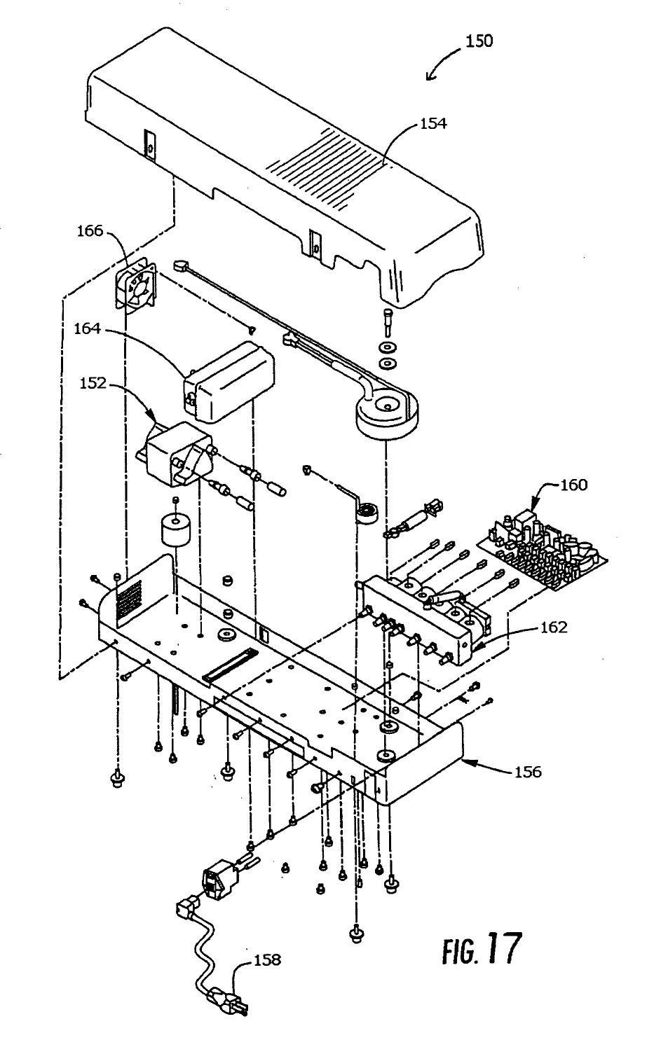

Each inflatable bladder 126 incorporates a port 144 (FIGS. 2, 4A, and 16) adapted to permit the flow of pressurized fluid into or out of the respective bladder 126. Each port 144 is adapted to receive a conduit, such as a hose 146, through which pressurized fluid is added to, or removed from, the respective bladder 126 by an inflating/deflating system 148 in response to an input from user input device 134 (FIG. 16), as will be described in greater detail below.

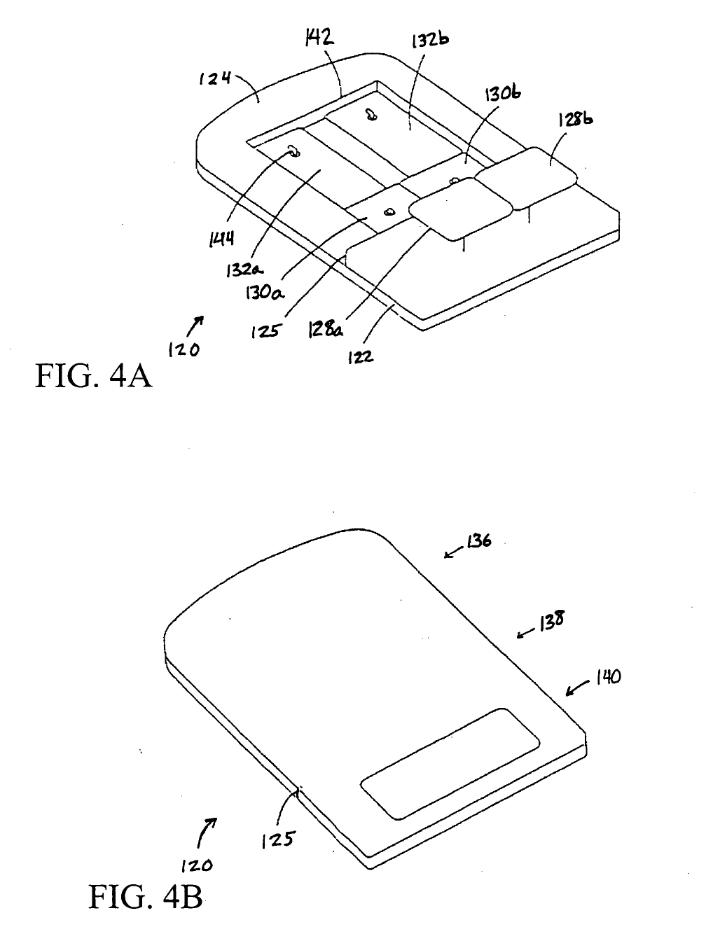

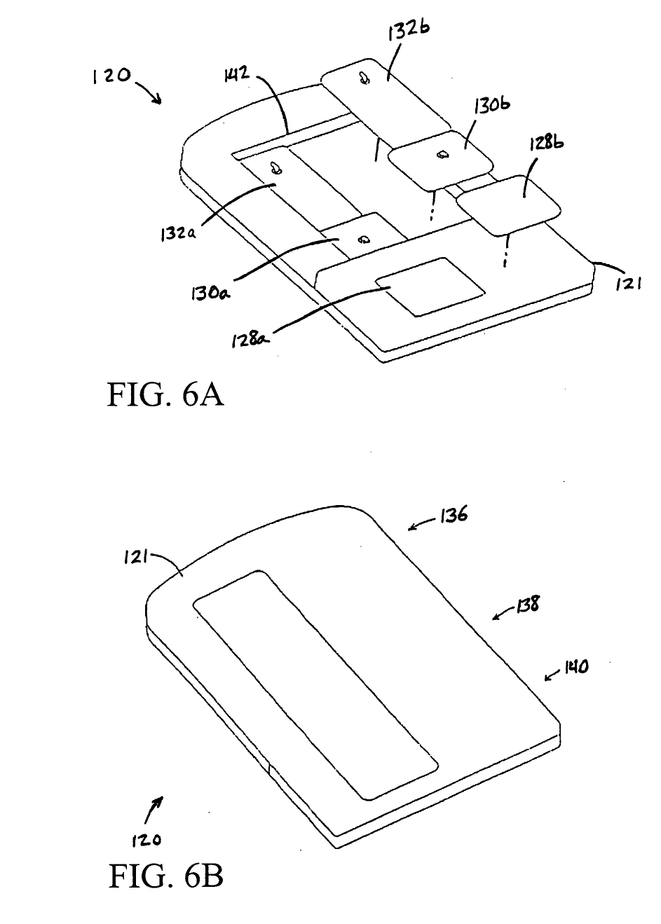

Accordingly, left and right sides of upper back region 136, left and right sides of lumbar region 138, and left and right sides of pelvis region 140 may be independently and respectively raised and lowered by inflating and deflating upper back bladders 132a, 132b, lumbar bladders 130a, 130b, and pelvis bladders 128a, 128b. For example, to turn the patient to the patient's left side, one or more of the right upper back bladder 132b, right lumbar bladder 130b, and right pelvis bladder 128b are inflated relative to the left upper back bladder 132a, left lumbar bladder 130a, and left pelvis bladder 128a, as shown in FIGS. 6A and 6B. Note that in FIG. 6B, as well as in FIGS. 4B, 5B, 9B, and 14B, the inflated or raised region of the respective patient lying surface is illustrated by lines forming a rectangle having curved corners. These lines are representative only and are simply used to designate a region.

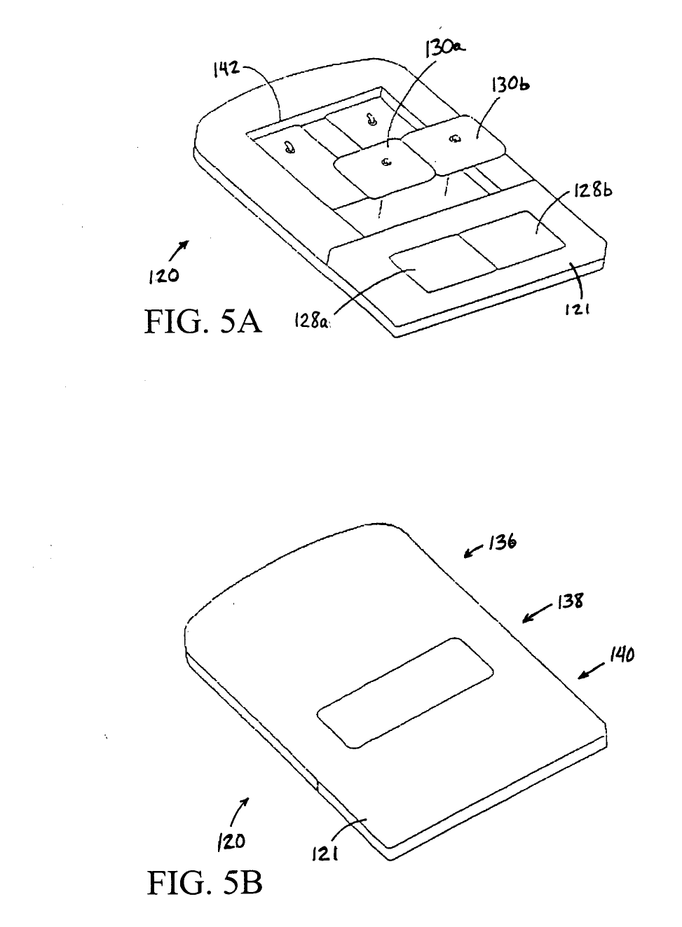

In the event that all bladders 126 are inflated prior to turning the patient, turning the patient to the patient's left side, for example, is accomplished by deflating one or more of the left upper back bladder 132a, left lumbar bladder 130a, and left pelvis bladder 128a. To raise the pelvis region 140 of the patient lying surface 120, and, thus, the patient's pelvis, the left and right pelvis bladders 128a, 128b are inflated, as shown in FIGS. 4A and 4B. Similarly, to raise the lumbar region 138 of the patient lying surface 120 and, thus, the patient's lumbar region, the left and right lumbar bladders 130a, 130b are inflated, as shown in FIGS. 5A and 5B. The upper back region 136 of the patient lying surface 120 and, thus, the patient's upper back, may similarly be raised.

Twisting of the patient's pelvis relative to the patient's upper back and lumbar region is accomplished, for example, by inflating one or more of the left pelvis bladder 128a, right lumbar bladder 130b, and right upper back bladder 132b relative to the right pelvis bladder 128b, left lumbar bladder 130a, and left upper back bladder 132a. Because any given bladder may be inflated or deflated independently from any other bladder, it will be appreciated that any combination of raising, lowering, twisting, or turning of the patient's upper back, lumbar region, and pelvis may be accomplished by selectively inflating and deflating bladders 126 of patient lying surface 120.

Inflatable bladders 126 are made of flexible and substantially gas-impermeable material, such as a rubber, coated fabric or a polymer, for example, or any material that is suitably strong, gas-impermeable, flexible, and resistant to abrasion and environmental degradation from contact with liquids, gases, and temperatures that are typical of hospital and patient care environments.

As noted above, bladders 126 are inflated or deflated by the passage of pressurized fluid through conduits or hoses 146 and controlled by the user via user input device 134, as shown in FIG. 16. For example, commonly assigned U.S. application Ser. No. 11/940,995, filed Nov. 15, 2007, which is hereby incorporated herein by reference, discloses a patient lying surface having an inflating/deflating system that may be adapted for use with the present invention.

With reference to FIG. 16, inflating/deflating system 148 includes user input device 134, a control assembly 150, and conduits or hoses 146. User input device 134 enables the user to selectively inflate or deflate any individual bladder 126, or to selectively inflate or deflate two or more bladders 126 simultaneously. For example, user input device 134 may enable the user to select a patient left-turn-assist function, wherein by pressing a single button (not shown), for example, three bladders located under the patient's right side are inflated relative to three bladders located under the patient's left side, as shown in FIGS. 6A and 6B. Similarly, by pressing a single button on user input device 134, the user causes left and right pelvis bladders 128a, 128b to inflate, thus raising the patient's pelvis. In a similar manner, user input device 134 may be programmed such that any combination of inflation or deflation of any bladders is effected by the user by selecting a single function at user input device 134. User input device 134 converts the user's selection into a signal, such as an electrical or radio or infrared signal, that is received by control assembly 150, as will be described in greater detail below.

Control assembly 150 converts the signal received from user input device 134 into corresponding inflation or deflation of one or more bladders 126. Pressurized fluid, such as air, is directed from an air pump 152 (FIG. 17) located within control assembly 150, or other pressurized fluid source (not shown), to the various bladders (FIG. 17). Control assembly 150 may be incorporated into patient lying surface 120, such as proximal to upper back region 136, or control assembly 150 may be mounted or secured apart from patient lying surface 120 on maternity bed 110. Control assembly 150 is enclosed by a control box top cover 154 and a control box bottom cover 156. A power cord 158 is connected to control assembly 150, as shown in FIG. 17.

An air main control board 160 is electrically connected to air pump 152 and a valve manifold assembly 162. Air is taken into and discharged from air pump 152 through a canister assembly 164. Canister assembly 164 may additionally absorb vibration and reduce noise generated by air pump 152. In the illustrative embodiment, air enters canister assembly 164 and proceeds to air pump 152 where it is pressurized and pumped out of air pump 152 and back through canister assembly 164. The pressurized air then passes through valve manifold assembly 162 and proceeds to one or more hoses 146 of inflating/deflating system 148. Hoses 146 conduct pressurized air from valve manifold assembly 304 to bladders 126 via ports 144. Valve manifold assembly 162 selectively distributes pressurized air from air pump 152 to bladders 126 according to user inputs sent from user input device 134 to air main control board 160 to valve manifold assembly 162. Similarly, valve manifold assembly 162 selectively vents pressurized air from bladders 126, such as through hoses 146, and into the atmosphere.

Alternatively or additionally, control assembly 150 may be powered by a battery (not shown), or control assembly 150 may be powered through the power source of the patient support apparatus or bed via power cord 158. Control assembly 150 may further incorporate a fan 166 to draw air out of control assembly 150. Optionally, control assembly 150 may incorporate various sensors or sensor-reading electronics (not shown), such as to detect the fluid pressure in any given bladder and use that information to automatically select whether to inflate or deflate selected bladders to achieve the function selected at user input device 134.

User input device 134 is operatively connected to the control assembly 150 to communicate therewith, such as via a communication wire 168. Alternatively, user input device 134 communicates with the control assembly 150 via wireless communications, such as radio frequency or infrared signal. User input device 134 is used by the health care provider or the patient to control the inflation and deflation of the inflatable bladders 126, 226, 326 of the patient lying surface 120, 220, 320. The control assembly 150 may be operatively connected to the patient support apparatus' or bed's communication network such that control of the patient lying surface 120 is effected through the support apparatus' or bed's control panel.

User input device 134 has a plurality of control buttons (not shown), or other input features. Control buttons may include, for example, Patient Turn-Assist Right; Patient Turn-Assist Left; Raise/Lower Back; Raise/Lower Left Back; Raise/Lower Right Back; Raise/Lower Lumbar, Raise/Lower Left Lumbar; Raise/Lower Right Lumbar; Raise/Lower Pelvis; Raise/Lower Left Pelvis; Raise/Lower Right Pelvis; Raise/Lower All, Stop, Lock, and Maintenance Call.

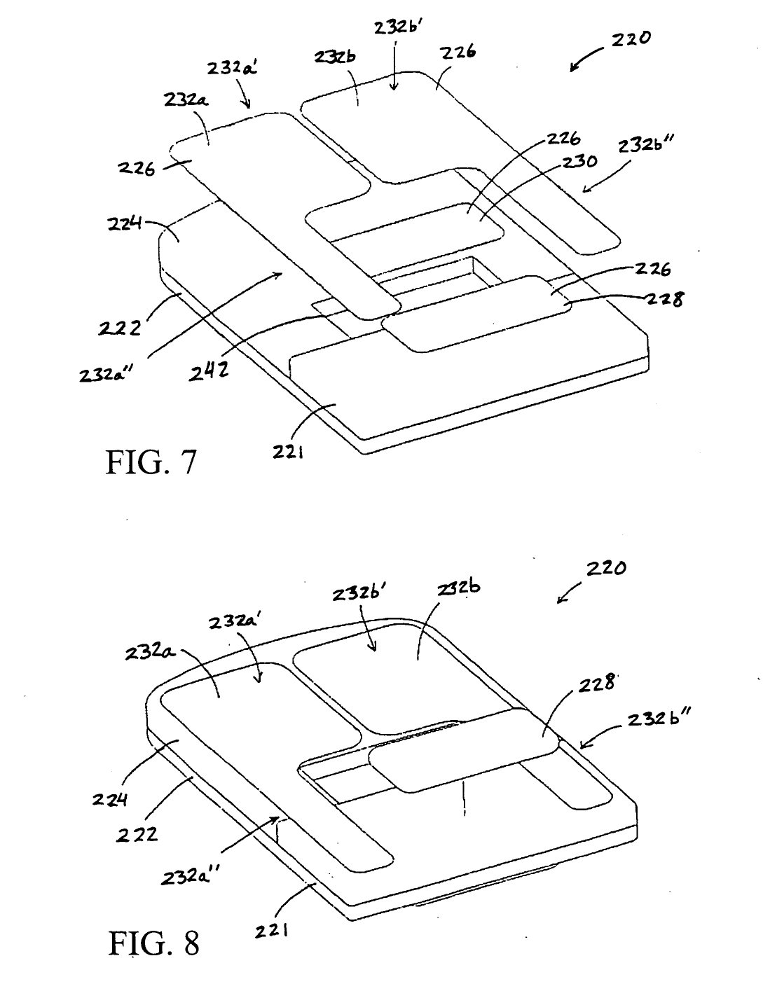

With reference to FIGS. 7-10, another embodiment of a patient lying surface 220 is illustrated, which has a cushion 221 comprising a top cushion layer 222 and a bottom cushion layer 224, and a plurality of lifting elements in the form of inflatable bladders 226, which are similarly arranged at cushion 221. Inflatable bladders 226 include a pelvis bladder 228, a lumbar bladder 230, and left and right lumbar/upper back/pelvis bladders 232a, 232b. Patient lying surface 220 is substantially similar in construction and function to patient lying surface 120 described above, such that a detailed discussion of similar features of patient lying surface 220 need not be repeated herein.

In the illustrated embodiment, bladders lumbar/upper back/pelvis bladders 232a, 232b comprise generally P-shaped bladders, with enlarged or wide portions 232a′, 232b′ and narrow stem portions 232a″, 232b″. Bladders 232a, 232b are arranged at cushion 221 such that wide portions 232a′, 232b′ of P-shaped bladders 232a, 232b are generally located at left and right sides, respectively, of an upper back region 236 of patient lying surface 220. Narrow stem portions 232a″, 232b″ of P-shaped bladders 232a, 232b are generally located at left and right sides, respectively, of lumbar region 238 and pelvis region 240 of patient lying surface 220. Narrow stem portions 232a″, 232b″ are oriented such that they are outboard of lumbar bladder 230 and pelvis bladder 228, as shown in FIG. 7.

Optionally, and as shown, bottom cushion layer 224 defines a cavity 242 that is adapted to receive one or more inflatable bladders 226, such as lumbar bladder 230. Although shown in FIGS. 7-10 as being of one-piece construction, it will be appreciated by those skilled in the art that lumbar bladder 230 may optionally be constructed of two or more independently inflatable bladders. Pelvis bladder 228 may be similarly constructed.

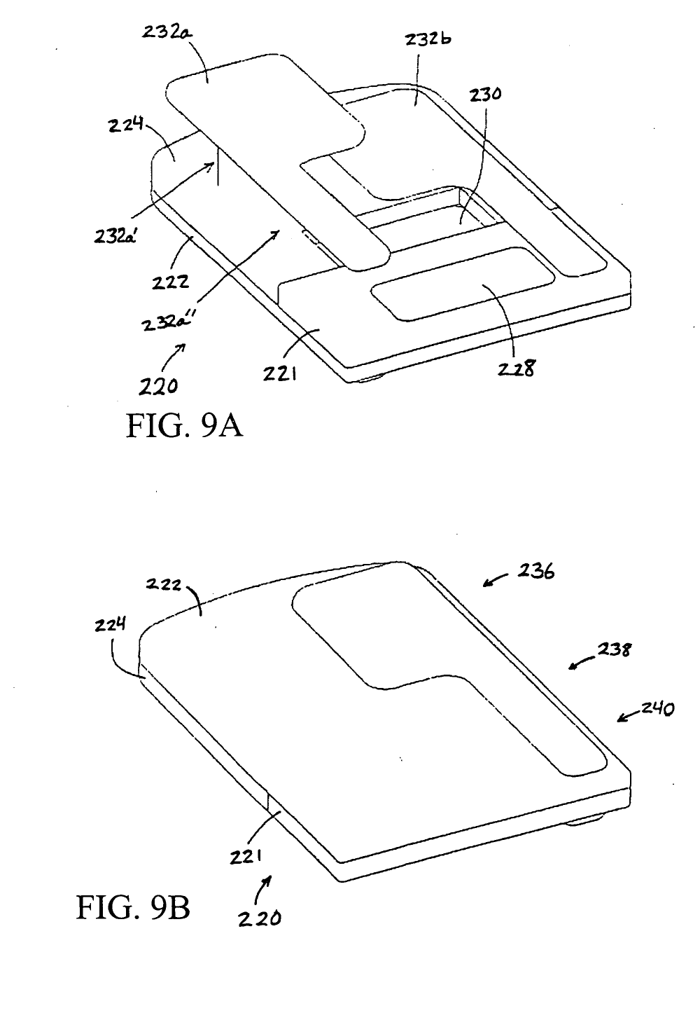

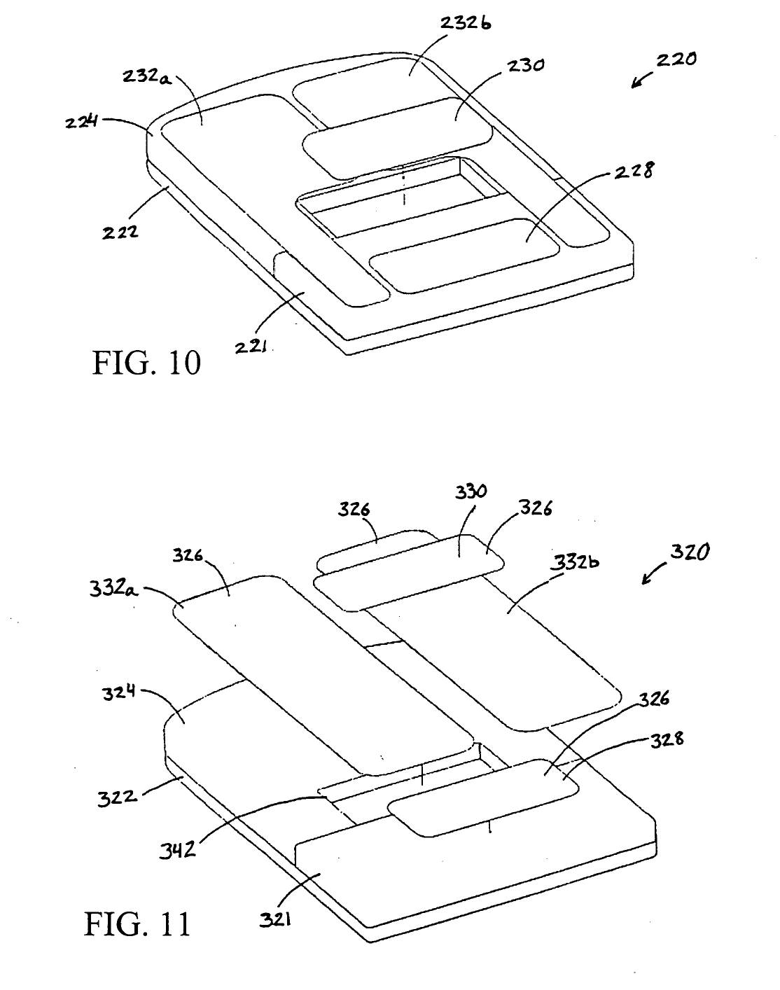

Accordingly, left and right sides of upper back region 236, left and right sides of lumbar region 238, and left and right sides of pelvis region 240 are independently and respectively raised and lowered by inflating and deflating P-shaped bladders 232a, 232b. Thus, for example, a patient is turned to the patient's right by inflating the left P-shaped bladder 232a (FIG. 9A), which results in raising a substantial portion of upper back region 236 and smaller outboard portions of lumbar region 238 and pelvis region 240 (FIG. 9B) to effect the turning of the patient to the right. Lumbar region 238 and pelvis region 240 are independently and respectively raised and lowered by inflating and deflating lumbar bladder 230 and pelvis bladder 228 (FIGS. 8 and 10, respectively). Where P-shaped bladders 232a, 232b are shaped and arranged as described herein, inflating one P-shaped bladder may cause the patient's upper back to twist relative to the patient's lumbar and pelvis regions due to the raised portion of upper back region 236 being larger than the raised portion of lumbar region 238 and pelvis region 240 of patient lying device 220.

Referring to FIGS. 11-14B, a third embodiment of patient lying surface 320 has a cushion 321 comprising a top cushion layer 322 and a bottom cushion layer 324, and a plurality of inflatable bladders 326 arranged at cushion 321. Inflatable bladders 326 also include a pelvis bladder 328, a lumbar bladder 330, and left and right lumbar/upper back/pelvis bladders 332a, 332b. Patient lying surface 320 is substantially similar in construction and function to patient lying surfaces 120 and 220 described above, such that a detailed discussion of similar features of patient lying surface 320 need not be repeated herein.

Optionally, and as shown, bottom cushion layer 324 defines a cavity 342 that is adapted to receive one or more inflatable bladders 326, such as lumbar bladder 330. Lumbar/upper back/pelvis bladders 332a, 332b are arranged at cushion 321 such that lumbar/upper back/pelvis bladders 332a, 332b are generally located at left and right sides, respectively, of an upper back region 336, a lumbar region 338, and a pelvis region 340 of patient lying surface 320. In the illustrated embodiment, lumbar/upper back/pelvis bladders 332a, 332b have a generally rectangular shape and overlap lumbar bladder 330 and pelvis bladder 328 at lumbar region 338 and pelvis region 340 of patient lying surface 320. Although shown in FIGS. 11-14B as being of one-piece construction, it will be appreciated that lumbar bladder 330 may optionally be constructed of two or more independently inflatable bladders. Pelvis bladder 328 may be similarly constructed.

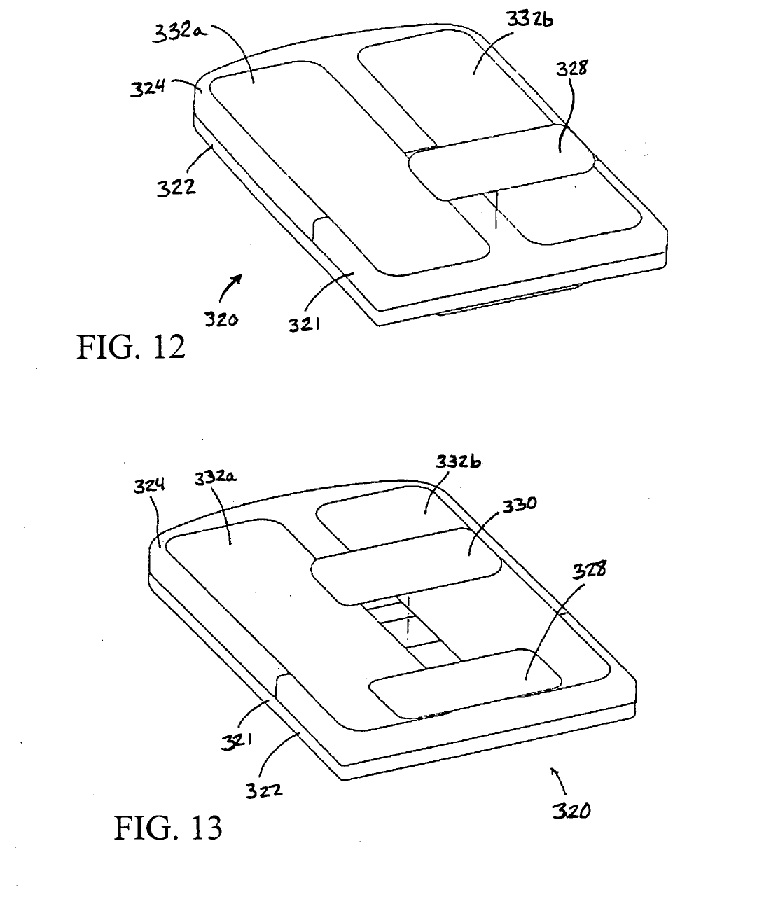

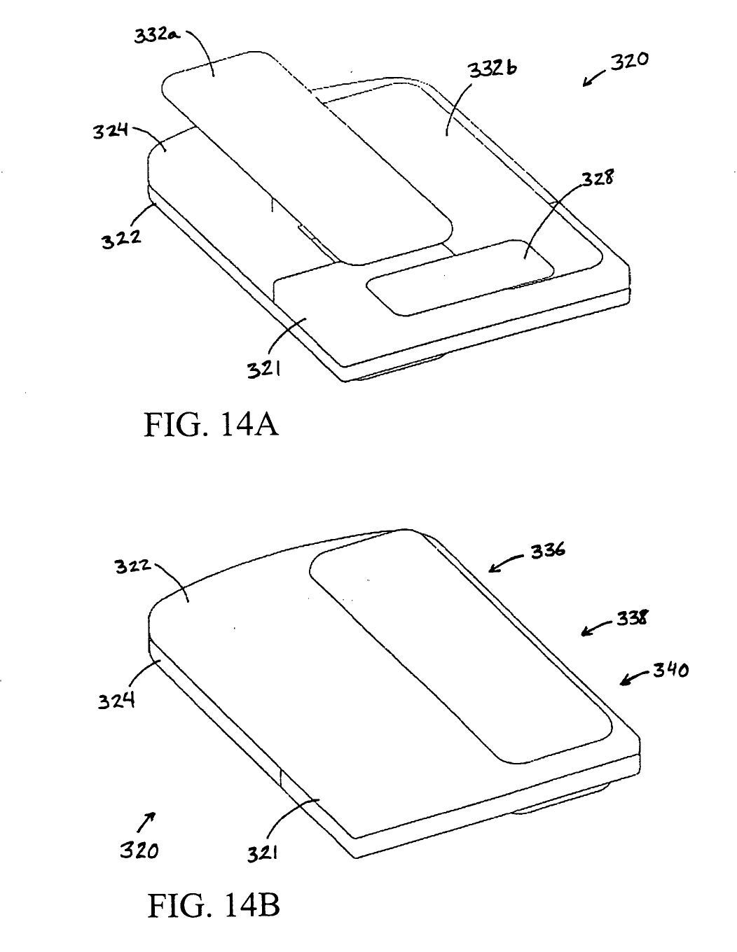

Accordingly, left and right sides of patient lying surface 320 are independently and respectively raised and lowered by inflating and deflating left and right lumbar/upper back/pelvis bladders 332a, 332b. Thus, for example, a patient is turned to the patient's right by inflating the left lumbar/upper back/pelvis bladder 332a (FIG. 14A), which results in raising a substantial portion of the left side of patient lying surface 320 (FIG. 14B) to effect the turning of the patient to the right. Lumbar region 338 and pelvis region 340 are independently and respectively raised and lowered by inflating and deflating lumbar bladder 330 and pelvis bladder 328 (FIGS. 13 and 12, respectively).

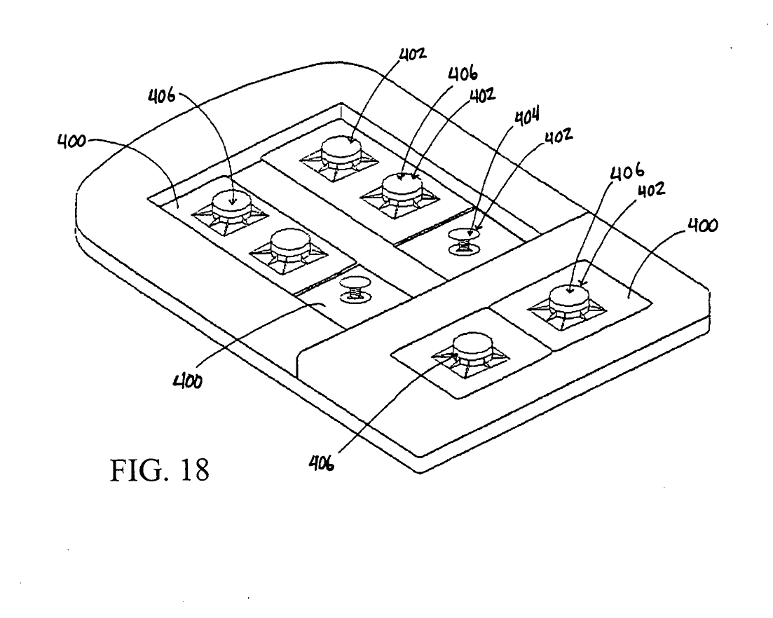

Although primarily described in the context of a maternity bed and in reference to a plurality of inflatable bladders, it will be appreciated by those skilled in the art that the patient lying surface of the present invention may incorporate other types of actuatable lifting elements or moveable members, such as rigid or semi-rigid panels 400, arranged beneath the patient, wherein the panels 400 are selectively raised and lowered by actuators 402, such as electric actuators 404, or hydraulic or pneumatic actuators 406, or the like, as shown in FIG. 18. The actuators 402 may be linear or rotary actuators, for example, or may comprise inflatable bladders disposed beneath the panels 400. Electric actuators 404, for example, may be controlled and selectively actuated and deactuated by a circuit board that sends power to each actuator such as through a conductive wire (not shown). Pneumatic or hydraulic actuators, for example, may be selectively actuated (or inflated or pressurized) or deactuated (or deflated or depressurized) by an inflating/deflating system similar to that described above with reference to FIGS. 16 and 17; It should further be understood that although the terms “air” and “pressurized fluid” are used throughout the specification and claims, those terms are intended to refer to any suitable fluid, gaseous or liquid.

Changes and modifications in the specifically described embodiments may be carried out without departing from the principals of the present invention, which is intended to be limited only by the scope of the appended claims, as interpreted according to the principles of patent law.

The embodiments of the invention in which an exclusive property or privilege is claimed are defined as follows:

1. A maternity bed comprising:
a patient lying surface, said lying surface having a pelvis region, a lumbar region, an upper back region, and left and right sides;
a plurality of actuatable lifting elements, said actuatable lifting elements generally arranged at said patient lying surface, wherein said actuatable lifting elements include left and right lifting elements located at least at said upper back region of said lying surface, a pelvis lifting element located at said pelvis region of said lying surface, and a lumbar lifting element located at said lumbar region of said lying surface; and
an actuator associated with each of said lifting elements, wherein said left lifting element is actuatable by a left actuator to raise the left side of a patient lying upon said lying surface and said right lifting element is actuatable by a right actuator to raise the right side of the patient for tilting the patient.

2. The maternity bed of claim 1, wherein said left lifting element comprises a left upper back lifting element adapted to raise only the left upper back region of the patient, and said right lifting element comprises a right upper back lifting element adapted to raise only the left upper back region of the patient.

3. The maternity bed of claim 1, wherein said lumbar lifting element comprises left and right lumbar lifting elements, said left lumbar lifting element being adapted to raise the left lumbar region of the patient, and said right lumbar lifting element being adapted to raise the right lumbar region of the patient.

4. The maternity bed of claim 1, wherein said pelvis lifting element comprises left and right pelvis lifting elements, said left pelvis lifting element being adapted to raise the left pelvis region of the patient, and said right pelvis lifting element being adapted to raise the right pelvis region of the patient.

5. The maternity bed of claim 1, wherein said left lifting element comprises a left P-shaped lifting element adapted to raise the left upper back region and at least portions of the left lumbar region and left pelvis region of the patient, and said right lifting element comprises a right P-shaped lifting element adapted to raise the right upper back region and at least portions of the right lumbar region and right pelvis region of the patient for tilting the patient lying upon said lying surface.

6. The maternity bed of claim 1, wherein said left lifting element comprises a left lumbar/upper back/pelvis lifting element adapted to raise the left lumbar, upper back, and pelvis regions of the patient, and said right lifting element comprises a right lumbar/upper back/pelvis lifting element adapted to raise the right lumbar, upper back, and pelvis regions of the patient.

7. The maternity bed of claim 1, further comprising a user input device for actuating said actuators.

8. The maternity bed of claim 1, wherein said actuatable lifting elements comprise inflatable bladders and said actuators comprise valves, and wherein said inflatable bladders are adapted to be inflated with air via said valves.

9. The maternity bed of claim 1, wherein said actuatable lifting elements comprise rigid panels.

10. The maternity bed of claim 9, wherein said actuators comprise one of pneumatic actuators, electric actuators, and hydraulic actuators.

11. The maternity bed of claim 1, further comprising a cushion disposed at said patient lying surface and above said actuatable lifting elements.

12. The maternity bed of claim 11, wherein said cushion comprises a cavity at a lower surface thereof, said cavity adapted to receive at least one of said actuatable lifting elements.

13. A maternity bed comprising:
a patient lying surface, said lying surface having a pelvis region, a lumbar region, an upper back region, and left and right sides;
a plurality of actuatable lifting elements, said actuatable lifting elements generally arranged at said patient lying surface, wherein said actuatable lifting elements include left and right P-shaped lifting elements; and
an actuator at each of said lifting elements, wherein said left P-shaped lifting element is actuatable by a left P-shaped lifting element actuator to raise the left upper back region and at least portions of the left lumbar region and left pelvis region of a patient, said right P-shaped lifting element is actuatable by a right P-shaped lifting element actuator to raise the right upper back region and at least portions of the right lumbar region and right pelvis region of a patient, for tilting the patient lying upon said lying surface.

14. The maternity bed of claim 13, further comprising a lumbar lifting element and a lumbar actuator, said lumbar actuator being actuatable to raise the lumbar region of the patient with said lumbar lifting element.

15. The maternity bed of claim 13, further comprising a pelvis lifting element and a pelvis actuator, said pelvis actuator being actuatable to raise the pelvis region of the patient with said pelvis lifting element.

16. The maternity bed of claim 13, further comprising a user input device for actuating said actuators.

17. The maternity bed of claim 13, wherein said actuatable lifting elements comprise inflatable bladders and said actuators comprise valves, and wherein said inflatable bladders are adapted to be inflated with air via said valves.

18. The maternity bed of claim 13, further comprising a cushion disposed at said patient lying surface and above said actuatable lifting elements.

19. The maternity bed of claim 18, wherein said cushion comprises a cavity at a lower surface thereof, said cavity adapted to receive at least one of said actuatable lifting elements.

20. A maternity bed comprising:
a patient lying surface, said lying surface having a pelvis region, a lumbar region, an upper back region, and left and right sides;
a plurality of actuatable lifting elements, said actuatable lifting elements generally arranged at said patient lying surface, wherein said actuatable lifting elements include left and right lumbar/upper back/pelvis lifting elements; and
an actuator at each of said lifting elements, wherein said left lumbar/upper back/pelvis lifting element is actuatable by a left lumbar/upper back/pelvis lifting element actuator to raise the left pelvis region, left lumbar region, and left upper back region of a patient, said right lumbar/upper back/pelvis lifting element is actuatable by a right lumbar/upper back/pelvis lifting element actuator to raise the right pelvis region, right lumbar region, and right upper back region of a patient, for tilting the patient lying upon said lying surface.

21. The maternity bed of claim 20, further comprising a lumbar lifting element and a lumbar actuator, said lumbar actuator being actuatable to raise the lumbar region of the patient with said lumbar lifting element.

22. The maternity bed of claim 20, further comprising a pelvis lifting element and a pelvis actuator, said pelvis actuator being actuatable to raise the pelvis region of the patient with said pelvis lifting element.

23. The maternity bed of claim 20, further comprising a user input device for actuating said actuators.

24. The maternity bed of claim 20, wherein said actuatable lifting elements comprise inflatable bladders and said actuators comprise valves, and wherein said inflatable bladders are adapted to be inflated with air via said valves.

25. The maternity bed of claim 20, further comprising a cushion disposed at said patient lying surface and above said actuatable lifting elements.

26. The maternity bed of claim 25, wherein said cushion comprises a cavity at a lower surface thereof, said cavity adapted to receive at least one of said actuatable lifting elements.

27. A method of turning a patient on a patient lying surface, said method comprising:
providing left and right pelvis actuatable lifting elements, left and right lumbar actuatable lifting elements, left and right upper back actuatable lifting elements, and an actuator adapted to actuate said actuatable lifting elements; and
executing at least one function chosen from (i) turning a patient left by actuating at least one chosen from said right pelvis actuatable lifting element, said right lumbar actuatable lifting element, and said right upper back actuatable lifting element; and (ii) turning the patient right by actuating at least one chosen from said left pelvis actuatable lifting element, said left lumbar actuatable lifting element, and said left upper back actuatable lifting element.

28. The method of claim 27, wherein said method further comprises executing at least one function chosen from: (i) raising or supporting the patient's upper back by actuating said left and right upper back lifting elements; (ii) raising or supporting the patient's left upper back by actuating said left upper back actuatable lifting element; (iii) raising or supporting the patient's right upper back by actuating said right upper back actuatable lifting element; (iv) lowering the patient's upper back by deactuating said left and right upper back actuatable lifting elements; (v) lowering the patient's left upper back by deactuating said left upper back actuatable lifting element; and (vi) lowering the patient's right upper back by deactuating said right upper back actuatable lifting element.

29. The method of claim 27, wherein said method further comprises executing at least one function chosen from: (i) raising or supporting the patient's lumbar region by actuating said left and right lumbar actuatable lifting elements; (ii) raising or supporting the patient's left lumbar region by actuating said left lumbar actuatable lifting element; (iii) raising or supporting the patient's right lumbar region by actuating said right lumbar actuatable lifting element; (iv) lowering the patient's lumbar region by deactuating said left and right lumbar actuatable lifting elements; (v) lowering the patient's left lumbar region by deactuating said left lumbar actuatable lifting element; and (vi) lowering the patient's right lumbar region by deactuating said right lumbar actuatable lifting element.

30. The method of claim 27, wherein said method further comprises executing at least one function chosen from: (i) raising or supporting the patient's pelvis by actuating said left and right pelvis actuatable lifting elements; (ii) raising or supporting the patient's left pelvis region by actuating said left pelvis actuatable lifting element; (iii) raising or supporting the patient's right pelvis region by actuating said right pelvis actuatable lifting element; (iv) lowering the patient's pelvis by deactuating said left and right pelvis actuatable lifting elements; (v) lowering the patient's left pelvis region by deactuating said left pelvis actuatable lifting element; and (vi) lowering the patient's right pelvis region by deactuating said right pelvis actuatable lifting element.

31. The method of claim 27, wherein said providing the actuatable lifting elements comprises providing inflatable lifting elements, and said actuator selectively inflates or deflates said inflatable lifting elements.
